(19) United States
(12) Patent Application Publication
(10) Pub. No.: US 2009/0240597 A1
(43) Pub. Date: Sep. 24, 2009

(54) System and method for managing recipient accounts

(76) Inventor: Jack Oswald, San Francisco, CA (US)

Correspondence Address: PERKINS COIE LLP, P.O. BOX 1208, SEATTLE, WA, 98111-1208, US

(21) Appl. No.: 12/383,134

(22) Filed: Mar. 20, 2009

Related U.S. Application Data
(60) Provisional application No. 61/038,370, filed on Mar. 20, 2008.

(51) Int. Cl. G06Q 30/00; G06Q 20/00; G06Q 99/00

(52) U.S. Cl. 705/26; 705/44; 705/1

(57) ABSTRACT

A system and method to use a recipient account by a user for the purchase of goods from a merchant. During the purchasing transaction, the user submits a recipient account identifier, which can be used to identify a recipient account maintained by a shipper, to the merchant. The merchant further receives a transaction request for the purchasing of goods to be shipped to the user. By using the recipient account identifier, the merchant can request a payment from the shipper. The shipper does not reveal the method of payment by the user to the merchant. Upon receiving a payment from the shipper, the merchant and the user can commit the purchasing transaction. The shipper can later be used to transfer the purchased goods from the merchant to the user, without revealing the user's address.

### CROSS REFERENCE TO RELATED APPLICATION

This application claims the benefit of U.S. Provisional Application No. 61/038,370, filed Mar. 20, 2008 (Attorney Docket No. 67605-8001.US00), which is incorporated by reference, including any appendices or attachments.

### BACKGROUND

A customer who purchases goods from a merchant can either pick up the purchased goods, or ask the merchant to send the goods. Typically the customer has to create a customer account with the merchant that includes at least shipping information, and often also includes payment information (e.g., credit card information).

When a customer attempts to use the customer account maintained by a merchant, additional steps are typically required to ship purchased goods to the customer. For example, the merchant may provide multiple shipping options with different prices. The customer can also select a preferred vendor from available shippers. Once the purchasing transaction is finalized, the merchant collects the payment from the customer based on the payment information provided in the sender account, and informs the chosen shipping vendor about the pending shipment. The shipper then comes to the merchant's storefront or warehouse to pick up the goods and transports the goods to the customer. A tracking code is often provided to the customer and the merchant.

The above approach becomes burdensome for a customer who interacts with a large number of merchants. For every business from which the customer wants to purchase goods, a separate customer account must be created by the customer. When more and more customer accounts get created, it becomes harder to keep track of and maintain these accounts, especially when a customer wants to make updates to some of his/her personal information. For example, if one of the credit cards registered with the customer accounts is expired, the customer must update the credit card information for each customer account. Similarly, when a customer moves to a new address, the shipping address must be changed for all of the customer accounts.

With customer accounts, the customer also lacks the flexibility in controlling and changing the delivery of the purchased goods. For example, when multiple orders are placed through different customer accounts, even if all of the purchased goods are transported by a single shipping vendor, each order is treated separately by each respective merchant without the knowledge of the other orders. Thus, rather than communicating directly with the shipping vendor to make a single update, the customer would have to contact each of the merchants to reschedule the delivery of the orders to a different date, or route the goods to a different address. In fact, rescheduling or rerouting is hardly an option offered by even the largest online resellers or shippers. Further, the shipping options are mainly controlled by the merchants. Thus, the customer has to interact with every business or shipping vendor in order to keep track of all the packages that are shipped at different times and/or from different shipping vendors, even though they are all being delivered to a single address. Thus, maintaining multiple customer accounts with different businesses substantially restricts the customer's shipping options and ability to track shipments and make changes in delivery parameters.

Security risks associated with customer accounts increase when multiple customer accounts have to be maintained. A single security breach at any one of the merchants can compromise the customer's confidential information. Also, customer accounts cannot protect against fraud. For example, an online business may ship out goods based on an order from a customer account, before realizing that the payment submitted by the customer account holder is fraudulent. Also, a customer may never receive the merchandise he/she ordered from a business, even though the customer tendered a payment to the customer account of the business.

### SUMMARY

To simplify the process of entering shipping addresses, selecting shipping service options, making online purchases through various merchants or onsite at physical stores, and to greatly increase the security of conducting online transactions, a recipient account, or shipper account, could be created to store all payment and shipping options, such as address(es) and preferred shipping service (e.g. overnight, 3-day, weekly schedule, etc.) for a user. There are usually three parties involved in a purchasing transaction that requires delivery: the consumer that purchases goods, the merchant that sells the goods, and the shipper that transports the purchased goods from the merchant to the consumer. Comparing to the number of online businesses available on the Internet, there are very few shipping vendors that can quickly and conveniently transport physical goods from the merchants to the consumers. The consumer uses the recipient account to interact between shippers and merchants. Depending upon the implementation, it may be possible for a single recipient account to interact with a user's various customer accounts and support different types of transactions. Recipient accounts can improve delivering flexibility and reduce security risks associated with online shopping.

Recipient accounts are managed by a recipient account management system, which can be implemented independently or by shippers such as USPS®, FEDEX® or UPS®, by banks such as Bank of America® or Chase®, or by card processing services such as VISA®, MasterCard® or American Express®. The recipient account management system can be implemented to allow a user to create, update, and delete his/her recipient account via interfaces provided by the system. Before initiating a purchasing transaction with a merchant, a user can create a recipient account to hold the user's personal information such as name, social security number (SSN), date of birth (DoB), etc. The created recipient account, which can be accessed via an account ID and password if appropriately implemented, can also store the user's payment methods for shopping and delivery. Further, the recipient account can include one or more addresses to which the user would like the purchased goods to be delivered. If maintained by an independent party, the recipient account can include one or more shippers the user intends to use. When managed by one of the shippers, the recipient account can be used to communicate with that shipper or with the shippers for comprehensive delivery arrangement. A recipient account may have a plethora of addresses pre-entered, or may be entered on-the-fly with each new purchase. In all cases, if the selected address is associated with a 3^{rd} party recipient account, that 3^{rd} party's recipient account ID can be entered into the user's recipient account as well. In these cases, both the purchaser as well as the 3^{rd} party recipient will be able to track the shipment and manage its delivery after it has been shipped.

Advantageously, since the recipient account becomes the repository for storing the user's personal information (e.g., SSN, DoB, age, etc), payment methods, and/or delivery addresses, etc, the user does not need to disclose any of the above confidential information to the merchants during sender account setup. In a subsequent purchasing transaction, the recipient account can be used to pay for the costs of the goods and the delivery. For example, when merchandise is ready to be checked-out at a merchant's web site, rather than submitting credit card or other payment methods, the user can input a recipient account identifier to the merchant. The recipient account identifier is a unique value that can be used to identify the user and his/her recipient account. Upon receiving a recipient account identifier, the merchant can forward the identifier and the details of the pending transaction to the recipient account management system for a payment confirmation. The payment confirmation process includes authenticating the user's identify, informing the user about a potential purchase from the merchant, sending a payment authorization to the merchant, sending payment method details so the merchant can process the transaction, and/or optionally transmitting an actual payment to the merchant. Upon receiving the payment confirmation, the merchant can be assured that the merchandise will be paid for, and can commit the purchasing transaction with the user. Advantageously, it is not necessary to reveal the user's personal information or payment method to the merchant.

The recipient account also allows a shipper to transport the goods from the merchant to the user, perhaps without the merchant even knowing the delivery address. For example, once the purchasing transaction is committed, the merchant or the user can communicate with the recipient account management system to arrange for the shipping of the goods from the merchant to the user. Based on the details of the purchasing transaction, a shipper can be assigned by the recipient account management system for the shipping task. The shipper can then schedule a trip to the merchant's storefront or warehouse to pick up the purchased goods. If no actual payment was transmitted during the payment confirmation process, the shipper can tender the exact payment amount to the merchant in exchange for the goods to be delivered at the time of pickup. Afterward, the shipper arranges for the transferring of the goods to the user based on an address defined in the recipient account and/or selected by the user, possibly without the merchant's knowing the delivery address. Whenever no confidential information is disclosed to the merchant, a recipient account provides better protections to the user in the purchasing transaction. The merchant can be assured that there is are sufficient funds for the goods, and the goods can be released only when the actual payment is received, whether processed by the merchant or by the recipient account management system. For the user, the risk of paying for, but not receiving the goods is also greatly reduced.

To further reduce the risks associated with online transaction, additional security protocols can be implemented in utilizing the recipient accounts. These security protocols ensure that a user's recipient account is not abused by fraudulent merchants. It also allows a merchant to verify a suspicious user. For example, when a suspicious online transaction initiated from an un-trusted web site uses a recipient account identifier, the recipient account management system can immediately forward the transaction to the user for further verification. Without the user's approval, the management system would decline the payment confirmation. In addition, if a merchant is unsure about a user's true identity, the recipient account management system can send a transaction passcode to the recipient account holder, and request the account holder to forward the passcode to the merchant. The merchant can then transmit the passcode with the online transaction back to the management system for comparison and verification. A correct passcode indicates that the user and the recipient account holder are the same party. Additional protocols can be employed to ensure that the user, the merchant and the shipper can be mutually trusted. It is also possible to limit access to recipient account functionality to merchant web sites that have a prior trusted contractual arrangement with the recipient account management system.

The recipient account can allow a user and a shipper to manage and arrange the delivery of packages purchased from various merchants. For example, the user can submit one request through the recipient account to re-route packages from different merchants to a new address. The shipper can also optimize the delivery routes and the delivery trips, since all shipments for a particular user can be consolidated in the user's recipient account. Further, if the user can provide some leeway to the shipper in determining a more efficient time for the delivery, the savings received by the shipper can be passed along to the user. Thus, a recipient account provides additional convenience and flexibility that are not available in the sender accounts. Further, a new service can be offered by a shipper that is based on delivering packages only on a periodic delivery schedule such as once per week or every other week. An example would be to deliver packages only every Tuesday afternoon between 2 PM and 5 PM.

### BRIEF DESCRIPTION OF THE DRAWINGS

FIG. 1 depicts an example of a system in which recipient accounts are utilized.

FIG. 2 depicts an example of a diagram to show the interactions among a consumer, a provider, and a shipper in utilizing a recipient account.

FIG. 3 depicts an example of authorization and authentication scenarios among a consumer, a shipper and a merchant in utilizing a recipient account.

FIG. 4 depicts an example of a process for a merchant in conducting a purchasing transaction that involves a recipient account.

FIG. 5 depicts an example of a process for maintaining and using a recipient account by a shipper.

FIG. 6 depicts an example of a process for using a recipient account by a consumer.

FIG. 7 depicts an example of a recipient account management system.

FIG. 8 depicts an example of a process for using a recipient account by a consumer.

### DETAILED DESCRIPTION

Techniques for maintaining and using recipient accounts are described. References in this specification to “an embodiment”, “one embodiment”, or the like, describe an example of feature, structure or characteristic. Occurrences of such phrases in this specification do not necessarily all refer to the same embodiment.

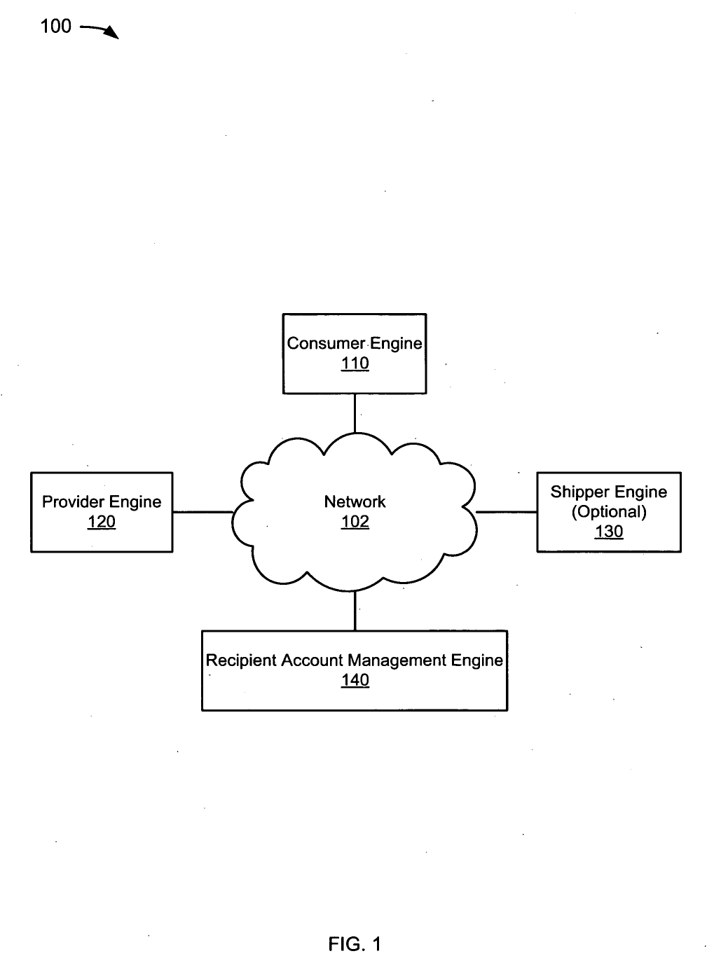

FIG. 1 depicts an example of a system 100 in which recipient accounts are utilized. The system 100 includes a network 102, a consumer engine 110, a provider engine 120, a shipper engine 130, and a recipient account management engine 140. The shipper 120 is optional because it is possible to provide items (such as software) across the network 102 without the shipper 120.

In the example of FIG. 1, the network 102 can include a networked system that includes several computer systems coupled together, such as the Internet. The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art. For illustrative purposes, it is assumed the network 102 broadly includes, as understood from relevant context, anything from a minimalist coupling of the components illustrated in the example of FIG. 1, to every component of the Internet and networks coupled to the Internet.

A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor.

The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The term “computer-readable storage medium” is intended to include physical media, such as memory.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor.

The bus can also couple the processor to the interface. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device.

In one example of operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs to configure the general purpose systems in a specific manner in accordance with the teachings herein, or it may prove convenient to construct specialized apparatus to perform the methods of some embodiments. The required structure for a variety of these systems will appear from the description below. In addition, the techniques are not described with reference to any particular programming language, and various embodiments may thus be implemented using a variety of programming languages.

The consumer engine 110 is an engine capable of acting on behalf of a consumer. As used in this paper, a consumer can be an entity, such as a person, a legal entity (e.g., a company), or any other entity for which a recipient account can be generated. As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

It should be noted that a “recipient” can mean the consumer who receives an item from a provider, or the engine acting on behalf of the consumer. Moreover, for items that can be delivered via the network 102, the recipient of a transmission can be the device acting on behalf of a consumer. For the sake of clarity, when the term “recipient” is intended to be indicative of a hardware device capable of communicating across the network 102, the recipient will normally be referred to as a “consumer engine.”

The consumer engine 110 can be implemented on a mobile, handheld computing/communication device, such as Personal Digital Assistant (PDA), cell phone, smart-phone, etc., a personal computer (PC), server-class computer, workstation, or some other known or convenient device. The consumer engine 110 is coupled to the network 102, and can communicate with other devices coupled to the network 102 in a known or convenient manner, such as via e-mail, Voice over IP (VoIP), HTTP requests originated from clicking of an ingress web hyperlink, a Wireless Application Protocol (WAP) hyperlink, a link embedded in a mobile terminated (MT) Short Message Service (SMS) message, a link embedded in a mobile originated (MO) SMS message, etc.

The provider engine 120 is an engine capable of acting on behalf of a provider, such as a merchant. The shipper engine 130 is an engine capable of acting on behalf of a shipper. The provider engine 120 and the shipper engine 130 are coupled to the network 102.

In one embodiment, the recipient account management engine 140 processes requests for recipient account and shipping transaction services, and responds directly or indirectly to these requests. The recipient account management engine 140 may contain a web server application such as Apache® HTTP Server, or Microsoft® Internet Information Server, etc, to process user requests in HTTP. Alternatively, the recipient account management engine 140 may be a mobile phone service provider that offers phone, text messaging, email, packet switching for accessing the Internet, and other mobile services. In one embodiment, the recipient account management engine 140 also interacts with internal or external systems of the provider engine 120. The provider engine 120 can be associated with an online or brick-and-mortar business that offers to sell merchandise. A customer can utilize the consumer engine 110 to browser and interact with a merchant associated with the provider engine 120, such as Amazon® or EBay®, and place purchasing orders directly. When a recipient account is used in a purchasing transaction, the provider engine 120 can interact with the recipient account management engine 140 for payment confirmation, and arrange with a shipper for the delivery of physical goods to the consumer.

In one embodiment, the recipient account management engine 140 is maintained by an independent party. The independent party can be a business venture that specializes in the marketing and servicing of the recipient accounts. The independent party can also manage the recipient account management engine 140 on behalf of, or in coordination with, one or more shippers. A shipper is a vendor that has facility and capability to quickly and conveniently ship physical goods domestically and/or internationally. Based on one statistic, US Postal Services® (USPS), FedEx® and UPS®, account for 32%, 31% and 25% of the US fast-delivery market shares, respectively. Thus, even if a consumer may interact with hundreds of online merchants, there is a high probability that one of the above three shippers are selected for delivering of the purchased goods. Thus, the recipient account management engine 140 can provide a common interface or a customized interface to each of the shippers without incurring substantial costs. Alternatively, the management engine 140 can also be established and managed by the shippers to complement the shippers' delivery and transportation businesses.

The recipient account management engine 140 can also be maintained by payment processors such as credit card processors (e.g., VISA®, MASTERCARD®, AMERICAN EXPRESS®, DISCOVERCARD®, etc), or credit card issuers (e.g., Band of America®, Chase®, etc). When implemented by the payment processors, the management engine 140 can integrate the payment information management with these financial institutes' payment system, allowing a more streamlined payment process.

In one embodiment, the recipient account management engine 140 provides interfaces to allow a consumer to create, update, and manage his/her recipient account. A recipient account is an account that stores a consumer's personal information, payment options, preferred delivery service and delivery addresses. Comparing to a sender account, which is mainly controlled by a particular merchant, the recipient account allows a hipper or an independent party to control the consumer's confidential information, in the meantime ensuring that purchasing transactions can be securely and properly conducted between the consumer and the merchant. Thus, regardless of how many merchants a consumer is trying to interact, a single recipient account could be sufficient in processing payments and arranging for shipment. Further, even if the consumer has to maintain multiple recipient accounts, each of which is controlled by a different shipper, the total number of recipient accounts is still much smaller than the potential number of sender accounts the consumer needs to set up. Therefore, the risk of losing confidential information through the sender accounts is greatly reduced when such information is entrusted to the recipient accounts.

Recipient accounts also reduce the amount of time and effort needed to keep common, frequently used pieces of information such as addresses and payment methods up to date and accurate. The recipient account minimizes the amount of time and effort needed to enter this information for each purchase transaction. The recipient account further provides a way to keep track of all shipments going to specific addresses and to manage when, where and how many packages get delivered. Thus, recipient accounts enable new services that do not today exist such as offering a new delivery service that is based on a weekly-only regular delivery schedule for all packages.

Advantageously, a recipient account management engine 140 can maintain both personal information, such as name, DoB, and SSN. In addition, the recipient account management engine can maintain repetitive use information, such as various addresses for use when shipping goods to a recipient, various payment methods, a preferred shipping service, and the like.

Advantageously, recipient accounts can reduce work by only requiring entry of personal or repetitive information once. If the information needs to be updated, it can be updated in one location (or just a few places) instead of having to update in many locations (e.g., at multiple merchants). Depending upon the implementation, the recipient account management engine can automatically provide relevant information to a merchant. Also depending upon the implementation, the recipient account management engine can keep the merchant from seeing any personal and/or repetitive information.

Advantageously, recipient accounts can provide capabilities and services that do not exist today. A user can track all shipments going to a specific address (or list of addresses) from one screen, be able to request a different delivery day or time, be able to request a shipment to be re-routed to a different address, be able to consolidate multiple shipments to be delivered on the same day, offer a new service that is a periodic delivery service, allow shippers to offer to change the delivery schedule, consolidate shipments in exchange for some value, allow shippers to provide escrow services, and other services that flow from an implementation of the techniques described in this paper.

Advantageously, recipient accounts provide enhanced security by allowing payment to be processed by a trusted party other than a merchant, hide some or all personal information of the recipient, hide the delivery address of the recipient, provide additional authentication mechanisms among consumer, merchant, and shipper, to name several.

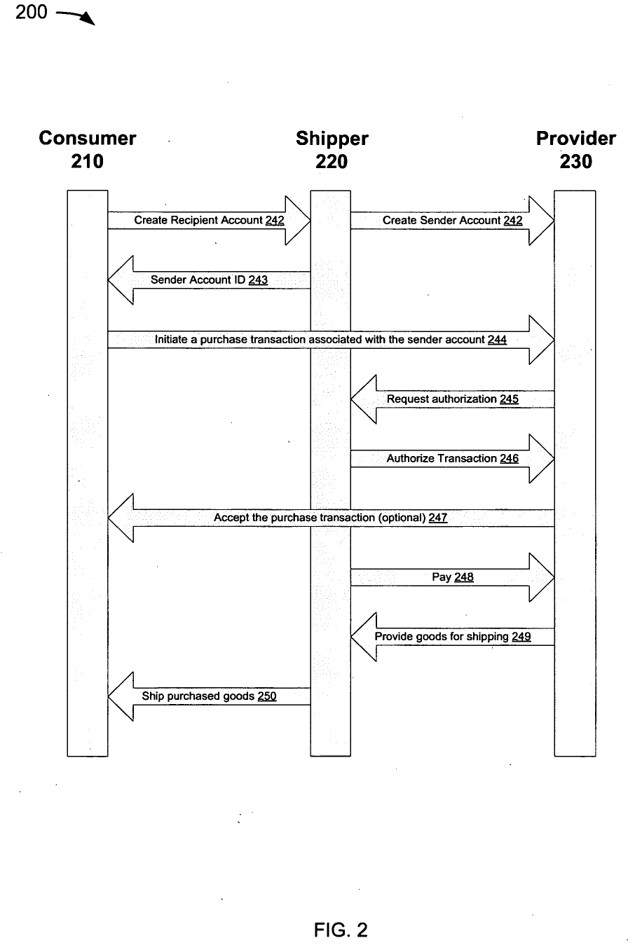

FIG. 2 depicts an example of a diagram 200 to show the interactions among a consumer, a provider, and a shipper in utilizing a recipient account. In the example of FIG. 2, the consumer 210 opens a recipient account with the shipper 220, and purchases goods from the provider 230. The shipper 220 pays the provider 230, and the provider 230 provides goods to the shipper 220 for shipment to the consumer 210. The provider 230 can be associated with an online or brick-and-mortar business. In some embodiments, the goods purchased by the consumer from the merchant require physical transportation. Alternatively, certain goods (e.g., music and movies, etc), which can be purchased and downloaded directly from the Internet, can also be physical shipped based on the consumer's preference. Note that some of the interactions can be optional; and not all of the interactions follow the same order described below.

In FIG. 2, the three vertical bars represent the consumer 210, the shipper 220, and the provider 230. The arrows among the three vertical bars represent various interactions that can be originated from one party (represented by the arrow's starting end) to another party (represented by the arrow's pointing end). A double arrow (with arrows on both ends) represents an exchange of information or a request-response communication between the two parties pointed by the arrows. Further, in this example, the recipient account management engine is assumed to be managed by the shipper 220. If the recipient account management engine is managed by an independent party, then the independent party would take the role of the shipper in FIG. 2; relevant interactions between the independent party and the shipper are described below.

In the example of FIG. 2, the consumer 210 creates a recipient account (241) with the shipper 220. When the recipient accounts are maintained by the shippers such as USPS, FEDEX and UPS, the consumer can create a separate recipient account with each of the shippers. Alternatively, an independent party allows the consumer to maintain a single recipient account for interacting with the different providers and shippers. In such a case, the consumer 210 and the provider 230 communicate with the independent party directly; and the shippers would be instructed by the recipient account management engine for picking up and delivering the purchased goods. Such an approach is advantageous since the consumer is only required to maintain a single recipient account, which simplifies the management of the account by the consumer.

It is assumed for illustrative purposes that the consumer 210 obtains credit from the shipper 220, which may be by providing checking account information, credit card information, or in some other known or convenient manner. Alternatively, the consumer 210 could maintain a balance with the shipper 220, and replenish the balance from time to time. For illustrative convenience, it is assumed that the consumer 210 has sufficient credit or balance to make a purchase transaction. However, if that were not the case, an additional step after the providers 230 requests authorization (245), could include the shipper 220 sending a request for additional funds or credit to the consumer 210, and continuing the transaction when the funds or credit are received.

In the example of FIG. 2, the shipper 220 creates a sender account (242) at the provider 230. A sender account is an account created with a merchant. For example, a consumer is often required to create a sender account with Amazon® before placing a purchasing order. The sender account 242 can be created specifically for the consumer 210, but the shipper 220 can substitute one or more values that are unique to the consumer 210 with values that are unique only to the shipper 220. For example, instead of providing the shipping address for the consumer 210, the shipper 220 could provide a shipping address associated with itself, and when it receives goods associated with the recipient account, ship the goods to the consumer 210. Depending upon the implementation, it is possible for the shipper 220 to shield the identity of the consumer 210 completely by handling all transactions with the provider 230 through the sender account.

Alternatively, or in addition, the consumer 210 could create a sender account (not shown) at the provider 230. In this alternative, comparing to a traditional sender account, which requires the consumer to disclose his/her confidential information, the sender account created by the consumer 210 only contains necessary information for logging-in to the merchant's system and placing purchasing orders with the merchant. The consumer 210 can opt out of submitting any additional personal information or any payment methods. Given the highly specific nature of a geographic location, being the consumer's home, place of business, school, etc, an attacker or abusive marketer can easily identify the consumer through a specific address, without accessing to other personal identifying monikers (e.g., name, SSN, DOB, etc). Thus, by omitting the submission of the addresses of the consumer 210 to the merchant 230, the risks associated with the losing of personal privacy can be greatly reduced.

In the example of FIG. 2, after a sender account is created via (242), the shipper 220 provides a sender account identifier (ID) (243) to the consumer 210. In the example of FIG. 2, the consumer 210 can use the sender account ID to communicate with the provider 230. In one implementation, this could be as simple as a username and password that the shipper 220 provided to the provider 230 when generating the sender account. The sender account could also have a master password, kept confidential by the shipper 220, and multiple lesser passwords that it makes available to consumers with recipient accounts. In general, the sender account ID needs to include data sufficient for the consumer 210 to initiate a purchase transaction with the provider 230.

In the example of FIG. 2, the consumer 210 initiates a purchase transaction associated with the sender account (244) with the provider 230. The purchase transaction can be initiated, for example, via web interfaces provided by the provider 230, via telephone call to a call center for processing, via the merchant's brick-and-mortar storefront, when the goods are sent later by shipment, or in some other manner.

In an alternative embodiment, where consumers can create their own sender accounts at the provider 230, to pay for the goods, the consumer 210 can submit a recipient account identifier (ID), in lieu of a credit card or other payment methods, to the provider 230. The recipient account identifier can be used by the recipient account management engine to uniquely identify the consumer and the recipient account. For example, the recipient account identifier can be an abstract number and character arrangement that does not reveal the true identity of the consumer 210. The recipient account identifier can be fixed; it can also be randomly generated by the recipient account management engine for a specific transaction. Even if the recipient account identifier is intercepted by a perpetrator, without further authentication and authorization, the identifier perpetrator cannot use the identifier to impersonate the consumer or cheat the merchant. Thus, the recipient account identifier can be used as a mechanism for receiving payments from the recipient account, without having access to a consumer's confidential information.

In the example of FIG. 2, the provider 230 requests authorization (245) from the shipper 220. The request will presumably include sufficient data for the shipper 220 to identify the recipient account, such as a recipient account ID. Depending upon the implementation, the shipper 220 may also be provided details of the pending transaction such as information about the goods to be purchased, the quantity of the goods, the total price, and the merchant's information, etc. However, it is also possible to prevent the shipper 220 from learning certain details of the transaction by utilizing appropriate protections. For example, after the shipper 220 creates the sender account, the consumer 210 can password-protect a portion of the account, and prevent the shipper 220 from learning about the details of the purchase. (In some cases, the shipper 220 might have to be informed of certain details, such as when explosives are shipped; certain other details are going to be discovered anyway, such as the weight of the goods purchased.)

Assuming the recipient account has sufficient credit and/or funds, the shipper 220 authorizes the transaction (246). The authorization would assure to the provider 230 that there are sufficient funds available in the consumer's recipient account for the purchasing transaction. Further, the recipient account management engine can deduct the purchase amount for the purchasing transaction. If for any reason the transaction does not go through, the deducted amount can be returned to the recipient account. Presumably, upon receiving the authorization from the shipper 220, which is acting as an agent for the consumer 210, the consumer 210 becomes responsible for buying the goods, and the merchant is contractually obligated for relinquishing the goods to the consumer. Alternatively, the recipient account management engine can take responsibility for transactions for which there are insufficient funds (presumably because a mistake was made), or the provider 230 can accept a deal where unshipped items need not be paid for. The recipient account can also be used to deliver payment details to the merchant so the merchant may process the payment.

Optionally, the provider 230 can inform the consumer 210 that the purchase transaction was accepted (247). This is optional because when the shipper authorized the transaction, the transaction was complete. However, it is expected that a consumer would want to receive confirmation of the details. In an implementation where the shipper 220 is privy to details of the transaction, the shipper 220 could send notification of the acceptance of the purchase transaction instead of the provider 230.

In the example of FIG. 2, upon proper authorization, the shipper 220 can pay (248) the provider. Payment could either be made immediately or upon pickup of the goods. If the recipient account management engine is maintained by an independent party, a message can be transmitted from the independent party, or from the consumer 210, to the shipper 220. In this case, the payment can be made to the shipper 220, who pays the provider 230 upon pickup, directly to the provider 230, who pays the shipper 220 to pick up the goods, or to both the shipper 220 and the provider 230 in the appropriate proportions. Furthermore, the shipper 220 can communicate with the provider 230 to determine whether to have the shipper picking-up the goods from the merchant, or to have the merchant dropping-off the goods at the shipper's location.

In the example of FIG. 2, after satisfying themselves that the goods and the payment match the transaction specifications, if necessary, the provider 230 provides the goods (249) to the shipper 220. The shipper 220 can become an escrow party in the purchasing transaction to ensure that all contractual requirements are satisfied. Such an approach is advantageous since it is hard to implement this service with sender accounts. Alternatively, if the payment is already transmitted, then the shipper 220 is only required to pick up the goods from the merchant. Further, the consumer 210 can opt to utilize its recipient account for managing the shipping addresses, but not for making a payment or payment confirmation to the provider 230. Thus, during purchasing transaction, the consumer 210 can use any conventional payment method to pay for the goods. When requesting for authorization (245) from a shipper 220, the provider 230 can communicate to the shipper 220 that no payment or payment confirmation is necessary. Thus, step 248 can be optional, as the goods are already paid for by other means. Still, consumer 210's personal information, payment information, and/or shipping information are not disclosed from the shipper 220 to the provider 230 at any time. The shipper as an alternative can also deliver the payment information details to the merchant who would perform the payment transaction.

In the example of FIG. 2, the shipper 220 ships the goods (250) to the consumer 210 using the address provided by the recipient account or selected by the consumer 210. Thus, throughout the purchasing and delivery processes, the shipping address is not necessarily revealed to the provider 230, and when not, the consumer 210 can be assured that his/her confidential information is kept as confidential as is intended by the implementation of the system.

Alternatively, the consumer can conduct purchasing transaction with a provider without a sender account. For example, many online transactions through EBay® or Craig's List® do not require the consumer to establish a sender account at the merchant. In this case, the provider can still use the recipient account identifier for payment confirmation. Similarly, the payment confirmation can also be utilized for the purchasing of goods that do not require shipment. Upon proper authorization, the provider can receive the payments with the approval of the consumer. To simplify the payment confirmation process, the consumer can link a recipient account to the provider's sender account during or after the sender account creation. The link allows the provider to expedite the payment confirmation process, without requiring any additional actions from the consumer.

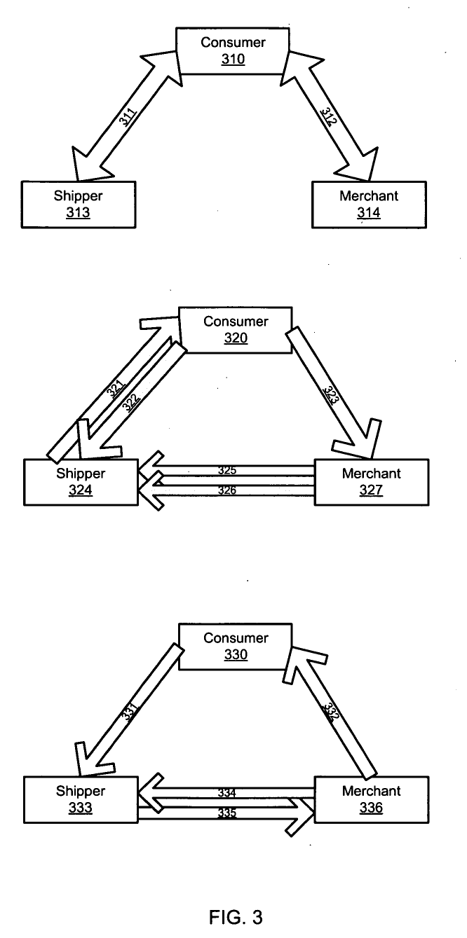

FIG. 3 depicts examples of authorization and authentication scenarios conducted among a consumer, a shipper and a merchant in utilizing a recipient account. Since most of the communications among the consumer, shipper and merchants are conducted online without a direct and face-to-face interaction, it would be essential to follow a proper protocol in authorizing and authenticating the parties to ensure that the information cannot be easily compromised and the transactions are genuine. Authentication is a process in which a consumer or a merchant's credentials are used to verify the consumer or the merchant's identity; and authorization is a process in which an authenticated consumer or merchant is allowed access to resources.

In FIG. 3, a consumer 310 needs to provide credentials to the shipper 313 and the merchant 314 in order to authenticate his/her identity. During an authentication process between the consumer 310 and the shipper 313, a recipient account ID and a password can be transmitted via 311 to the shipper to access the recipient account. Similarly, sender account ID and password can be passed to the merchant 314 via 312 for accessing the consumer's sender account. In one embodiment, when a particular merchant 314 has mutual trust with a shipper 313, the merchant 314 can establish a special trust link to the shipper 313 to allow an expedited authentication process. To configure the special link, once a consumer is authenticated by the merchant 313, the merchant can provide a separate communication mechanism (e.g., a new window, etc) to allow the consumer to input his/her recipient account credentials. If the consumer can successfully log into his recipient account through the merchant's communication mechanism, the merchant can be certain that the consumer owns the logged-in recipient account, and this recipient account can be linked with the sender account through the special trust link. The special trust link can be saved for further usage. During a subsequent purchasing transaction, the merchant 314 and the shipper 313 can communicate among each other through the pre-established special trust link to enable the consumer 310 to use the recipient account without additional authentication processes. Such approach is similar to using a credit card that has been previously saved in the sender account for quick purchase.

In one embodiment, when the identity of a consumer 320 is in question, additional authentication and authorization processes are required to ensure the security of online transactions, even if there is- mutual trust between the merchant 327 and the shipper 324. In order to make sure that nobody can easily impersonate the consumer 320 and initiate fraudulent purchasing and shipping of goods, the merchant 327 can cooperate with the shipper 324 to perform further authenticating and authorizing verifications. Because the recipient account possesses sensitive personal information, extra precaution is required even when proper credentials are provided to access the sender account at the merchant 327's system. Thus, during a purchasing transaction between a consumer 320 and a merchant 327, upon receiving a payment confirmation request 325 from the merchant 327, the shipper 324 can transmit the transaction details to the recipient account holder via a separate communication 321. If the recipient account holder and the consumer 320 are the same party, then the consumer 320 would be able to log in to his recipient account via 322 and see the transaction details.

In one embodiment, after having logged into the recipient account, the recipient account holder can double-check the transaction details and approve the transaction. Upon receiving the account holder's response, the shipper 324 can continue its payment confirmation process, and a payment or payment confirmation can be returned to the merchant 327. If no approval is received from the recipient account holder, then the shipper cannot release additional information or transmit the payment confirmation. Such an approach is advantageous since the separate email message is less likely to be intercepted by a malicious user. However, the process may require a true consumer to interrupt his purchasing transaction in order to perform the approval process. Alternatively, if the merchant and the shipper have mutual trust, the merchant can integrate the approval process into its own purchase transaction, and request the consumer to log in the recipient account management engine via the merchant, and perform a streamlined approval process.

In one embodiment, the merchant can use a passcode to verify whether the consumer is the proper recipient account holder, without requiring the recipient account holder to log in to the recipient account. The passcode can be a unique number and/or string randomly generated by the merchant 327. When requesting a payment confirmation from the shipper 324, the passcode can be included along with the transaction details and the recipient account identifier in the payment confirmation request 325. The passcode is then sent along with the transaction details via 321 to the recipient account holder. The account holder can retrieve the passcode from the message 321, and submit the passcode back (323) to the merchant 327. Thus, if the passcode sent via message 323 matches the original passcode send from the merchant 327, the merchant can be assured that the consumer is indeed the recipient account holder. Alternatively, the shipper 323 can generate a separate passcode which can be retrieved by the recipient account holder during login 322. The shipper's passcode can also be forwarded by the recipient account holder to the merchant 327, which in turn resubmit the shipper's passcode to the shipper 324 via message 326 for double verification. By using these authentication protocols, the shipper and the merchants can be ensured that the consumer is indeed the recipient account holder.

In one embodiment, additional security protocols can also be adapted by the shipper 333 for authenticating the merchant 336. For example, when the merchant 336 submits a payment confirmation request 334 to a shipper 333 for establishing a direct link with respect to a certain consumer 330, the shipper 333 can initiate a separate authentication message 335 to the merchant 336 with a dynamically generated passcode. The merchant 336 is then required to send the shipper's passcode to the consumer 330 via a message 332. The consumer 330 can then log into his/her recipient account at the shipper 333, and transmits the shipper's passcode to the shipper 333 via the message 331. Upon receiving the passcode, the shipper 333 can verify whether the party who sent a payment confirmation request is indeed the merchant 336 the consumer 330 is engaging a purchasing transaction with. Based on the proper transferring of a passcode among the consumer 330, the shipper 333, and the merchant 336, each of the three parties can be assured that the other two parties are aware of the purchasing transaction. Thus, the above various protocols can be deployed to prevent an impersonator who hacked into a sender account from making a purchase of with the merchant. The shipper can also prevent an abusive merchant who wants to retrieve payment from the shipper without the consumer's approval.

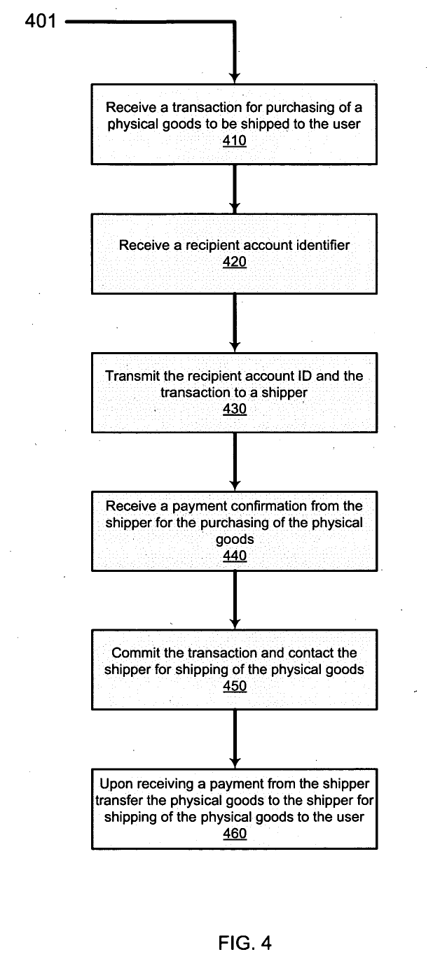

FIG. 4 depicts an example of a process 401 for a merchant in conducting a purchasing transaction that involves a recipient account. The process 401 can be performed by computer logic that may comprise hardware (e.g., special-purpose circuitry, dedicated hardware logic, programmable hardware logic, etc.). The process 401 can also be implemented in software (such as instructions that can be executed on a processing device), firmware or a combination thereof embedded in hardware components. In one embodiment, machine-executable instructions for the process 401 can be stored in memory and executed by a processor.

In the example of FIG. 4, at block 410, a merchant receives a transaction request from a consumer for the purchasing of physical goods to be shipped to the consumer. The request can be transmitted via the consumer's computer device displaying a web interface. The request can also be automatically initiated by the merchant. For example, the consumer may sign up to a merchant, which is a book club, to periodically purchase a book of the month. Further, the transaction request can be initiated after the consumer has previously created a sender account maintained by the merchant, and have logged into the sender account. In one embodiment, the sender account maintained by the merchant does not contain any consumer's confidential information that can cause a security breach.

At 420, the consumer transmits a recipient account identifier to the merchant as a method of payment. If a recipient account has previously been linked with the sender account, step 420 can be optional. The recipient account identifier provides information that allows the merchant to identify and communicate with a specific shipper. For example, the recipient account identifier can identify a specific shipper (e.g., USPS, FEDEX or UPS) that is maintaining the recipient account. Further, the recipient account identifier also includes a unique value that can be used by the recipient account management engine for identifying the recipient account. At block 430, the merchant transmits the recipient account identifier and the purchasing transaction details to the shipper. The transaction details include information about the specific goods the buyer is interested, the quantity, as well as the total price, etc.

At 440, upon receiving the recipient account identifier and the transaction details, the shipper can determine whether the recipient account holder has a sufficient fund to pay for the goods to be purchased in the transaction. If there is a sufficient fund, the shipper can transmit a payment confirmation in respond to the request received from the seller. Optionally, the shipper can deduct the purchase amount from the recipient account to reserve such funds for the completion of the transaction. If within a predetermined amount of time the deducted funds are not transferred to the seller in exchange for the goods, the funds can be returned to the recipient account. Further, if the consumer utilizes other means to pay for the goods, then no payment would be deducted or reserved from the consumer's recipient account, and no payment confirmation would be sent from the shipper or received by the seller. In this case, step 440 can be optional, and process 401 can proceed directly from 430 to 450.

In one embodiment, in order to verify the identities of the merchant and the consumer, the shipper may optionally perform additional authentication and authorization processes, as described above. Only upon receiving proper confirmations from the consumer or from the merchant would the shipper release the payment confirmation. At block 440, the payment confirmation sent from the shipper is received by the merchant. The payment confirmation does not reveal what mechanism is used to secure the payment or where the goods will be shipped to. However, the payment confirmation ensures that if the transaction is committed by the consumer, there would be a sufficient fund to fulfill the purchasing of the goods. At 450, the merchant receives a user submission committing the purchase transaction. Once the transaction is committed, the merchant can contact the shipper defined by the recipient account for the shipment of the purchased goods. At 460, upon receiving from the shipper the proper amount of the payment, the merchant can release the goods to the shipper. From the perspective of the merchant, the purchase contract with the consumer is completed.

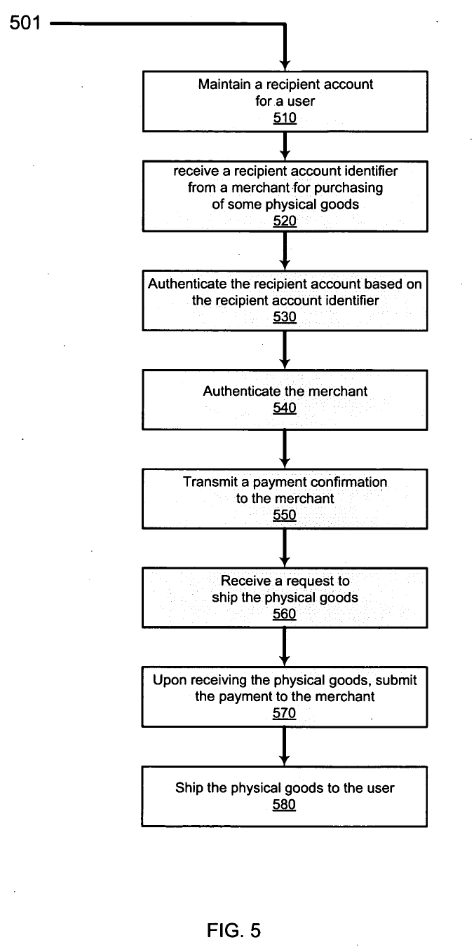

FIG. 5 depicts an example of a process 501 for maintaining and using a recipient account by a shipper. The process 501 can be performed by computer logic that may comprise hardware (e.g., special-purpose circuitry, dedicated hardware logic, programmable hardware logic, etc.). The process 501 can also be implemented in software (such as instructions that can be executed on a processing device), firmware or a combination thereof embedded in hardware components. In one embodiment, machine-executable instructions for the process 501 can be stored in memory and executed by a processor.

At 510, the shipper account management system maintains a recipient account for a consumer. In one embodiment, the management system is controlled and managed by the shipping vender (i.e., shipper). Alternatively, the management system can be implemented independently and on behalf of multiple shipping vendors. At 520, the shipper account management system receives a recipient account identifier from a merchant with respect to a purchasing transaction for some physical goods. The recipient account identifier is for uniquely identifying a recipient account that has been previously created by a consumer in the shipper account management system. Along with the recipient account identifier, the management system also receives details about the purchasing transaction, such as the description of the physical goods, the purchase quantity and price, etc. Alternatively, if the recipient account is utilized for providing a delivery address and/or a delivery service to the merchant, then the transaction details are not required to transmit to the management system.

At 530, the management system performs authentication and authorization processes based on the recipient account identifier and the purchasing transaction details. In one embodiment, the recipient account holder (i.e., the consumer) can input a password to authenticate the recipient account. The account holder can also be required to confirm the specific purchasing transaction by affirmatively approve the goods to be purchases, their quantity and prices, etc. Further, the account holder may be required to forward a transaction passcode to the merchant and awaits the merchant to transmit the transaction passcode to the shipper account management system for verification. The process 501 can proceed forward after the management system is satisfied that the consumer, the merchant and the purchasing transaction are legitiate. At 540, a similar process can also be required to authorize the merchant. For example, the management system can request the merchant to forward a transaction passcode to the consumer, who can relay the passcode back to the shipper account management system for verification. Alternatively, the authentication and authorization processes can be performed upfront before the initiation of the purchasing transaction. Such an approach is advantageous since it significantly simplifies the steps required during the purchasing transaction, especially when there is a pre-established trusted relationship, mutually authenticated, between the merchant and the shipper account management system.

At 550, upon satisfactory confirmation of the consumer, the merchant and the purchasing transaction, the shipper account management system can transmit a payment confirmation to the merchant. Based on the transaction requirement or consumer's preference, the shipper account management system can also transfer the exact payment to the merchant. After receiving the payment confirmation or the actual payment, the merchant can commit the purchasing transaction, and the shipper account management system would record such a purchase as a pending transaction, and in anticipation of the future shipment, deduct the exact payment from the consumer's credit card or checking account based on the payment options defined in the recipient account. Alternatively, if the consumer prefers to pay for the goods via a different means (e.g., paying directly with the consumer's credit card, using available credits in the sender account, or having the recipient account delivering the payment details to the merchant, etc), then no payment would be transmitted from the shipper account management system to the merchant. In this case, step 550 can be optional, and process 501 proceeds from 540 to 560 directly.

At 560, the shipper account management system receives a shipping request from either the merchant or the consumer. The shipping request provides the directions for picking up the purchased goods. The management system can optionally evaluate the shipping request with its internal transaction record to ascertain that the shipping request complies with the transaction records received at 520. Afterward, the management system can schedule for the picking up and delivery of the goods according to its own schedule, the merchant's availability, and/or the consumer's preference. At 570, if the goods are not paid for at 550, upon receiving the goods from the merchant, the shipper can pay for the amount that the shipper account management system has reserved at 550. Such a payment can be consolidated and being transmitted based on the agreements between the shipper and the merchant. From the perspective of the merchant, since the merchant has no knowledge of the shipping address, the purchasing transaction is deemed completed, and the shipper is entrusted with the delivery of the goods to the consumer. If the goods are already paid for, then no payment would be submitted by the shipper to the merchant.

At 580, the shipper delivers the physical goods to the consumer based on the address selected in the recipient account. During the delivery process, the merchant can track the shipment to determine whether the goods are delivered or not. However, no payment or delivery details (e.g., shipping address) are provided to the merchant throughout the process. Still, the merchant can be assured of the security of the transaction and the reliabilities of the shipper and the consumer.

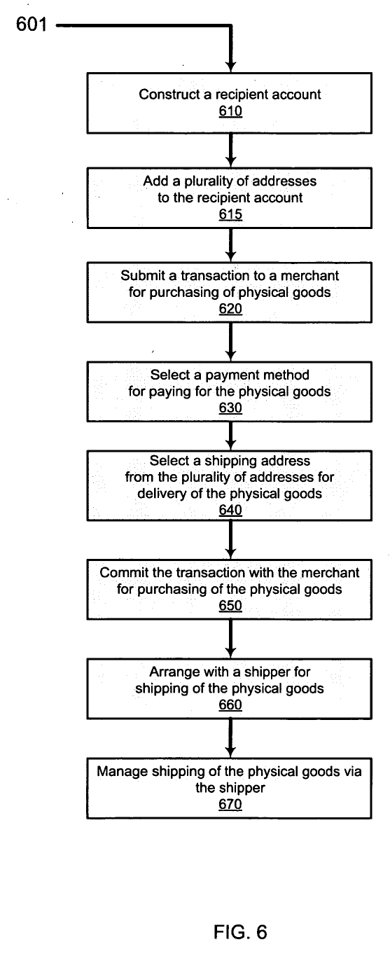

FIG. 6 depicts an example of a process 601 for using a recipient account by a consumer. The process 601 can be performed by computer logic that may comprise hardware (e.g., special-purpose circuitry, dedicated hardware logic, programmable hardware logic, etc.). The process 601 can also be implemented in software (such as instructions that can be executed on a processing device), firmware or a combination thereof embedded in hardware components. In one embodiment, machine-executable instructions for the process 601 can be stored in memory and executed by a processor.

At 610, by using a client device, a consumer can use the interface of a shipper account management system to construct a recipient account. In the recipient account, the user can further provide certain personal information which may not be shared with other merchants or shipping vendors. At 615, the consumer adds multiple addresses to the recipient account. By managing all the addresses from a recipient account, the consumer is enabled to manage the delivery of goods purchased from various providers and/or shipped by different shippers. At 620, the consumer can submit a transaction for the purchasing of some physical goods to a merchant. In one embodiment, the merchant has an online web site for receiving such a transaction. Alternatively, the retailer can be a brick-and-mortar business with capability of interacting with a shipper account management system. At 630, the consumer can define in his/her recipient account a specific payment method for paying for the transaction. The recipient account can include multiple payment options, which can be previously defined or quickly created. The consumer can specify a particular credit card as a default payment option for all transactions. The consumer can also select a preferred option or a preferred delivery service during the transaction. For example, when received a notice from the shipper account management system with respect to a particular transaction, the consumer can evaluate the transaction for its legitimacy. After confirming that the transaction is accurate in describing the specification, quantity and price of the goods to be purchases, the consumer can confirm the transaction and select a payment option. Afterward, the shipper account management system can deduct the payment amount from the consumer defined payment option, and transmit a payment confirmation or actual payment to the merchant.

At 640, the consumer can also select a shipping address from the addresses stored in the recipient account for the delivery of the physical goods. For example, the consumer may maintain several addresses in the recipient account, some personal addresses, and others for business. Some of these addresses may be for delivery to 3^{rd} parties whom may also have recipient accounts. When the 3^{rd} party's recipient account is specified, both the consumer and the 3rd party may be able to track the shipment as well as interact and modify the delivery parameters after shipment has begun. Thus, the address selection allows the consumer to arrange for the shipping of all purchased goods from a single recipient account. Note that steps 630 and 640 can also be performed upfront during the creation of the recipient account or before any purchasing transaction. At 650, once the merchant receives the payment confirmation from the shipper account management system and is satisfied with the identity of the consumer and the shipper, the consumer is allowed to commit the purchasing transaction. Afterward, a contract is established among the consumer, the shipper and the merchant for the purchasing and delivery of the physical goods. At 660, the consumer can arrange with the shipper for the shipping of the physical goods from the merchant's place to the consumer. Alternatively, the shipper can be automatically informed by the shipper account management system to pick up the delivery.

At 670, the consumer can manage the shipment of goodsvia the shipper and/or the shipper account management system. The consumer can see all shipments which are being handled by a specific shipper. Screens and reports could be generated by the shipper account management system to show what packages are predicted to arrive on which days and/or from which merchants. Further, the consumer can also make changes to the delivery date, delivery location, or the combination thereof, by package or groups of packages. The consumer can further request to have a package stored and delayed for delivery for a period of time, possibly for an additional fee. For example, if five packages are scheduled to be delivered on a particular week, rather than receiving one package on each of the five week days, the consumer can request that all five packages to be delivered in one weekday.

For example, via his/her recipient account, the consumer can see that multiple packages from different sellers are being delivered by the same shipping vendor to the consumer's address. By making an update through the recipient account, the shipping vendor can be informed that all of these packages are consolidated for a single-day delivery, even if these packages are originally scheduled to be delivered at different dates. Without a recipient account, it is burdensome for the consumer to contact all the sellers to coordinate their shipping in order to have all the packages arriving at a same day. In another example, through his/her recipient account, the consumer can route the pending packages to a different address, without having to directly communicate with the shipping vendor or the sellers. Thus, the consumer can be in control of the specific packages being delivered based on the date and the address the consumer prefers, or can negotiate with the shipper via the recipient account management service.

Even without the consumer's inputs, recipient accounts can greatly enhance the shipping vendor's delivery efficiency. For example, when a shipping vendor manages the recipient account management system, all the pending shipping tasks can be analyzed for an efficiency evaluation. If the consumer can provide some leeway to the shipper in determining a more efficient time and route for delivery, some or all of the savings received by the shipper can be passed along to the consumer. Thus, the recipient accounts not only allow the consumers, the shipping vendors, and the goods providers to track the delivery, but also provide services that are not available via sender accounts. Such a service enabled by the recipient account system can offer a once-per-week delivery schedule for all packages that could be delivered on a particular day-of-the-week. Whichever packages were not at the delivery staging area in time would be delivered the following week.

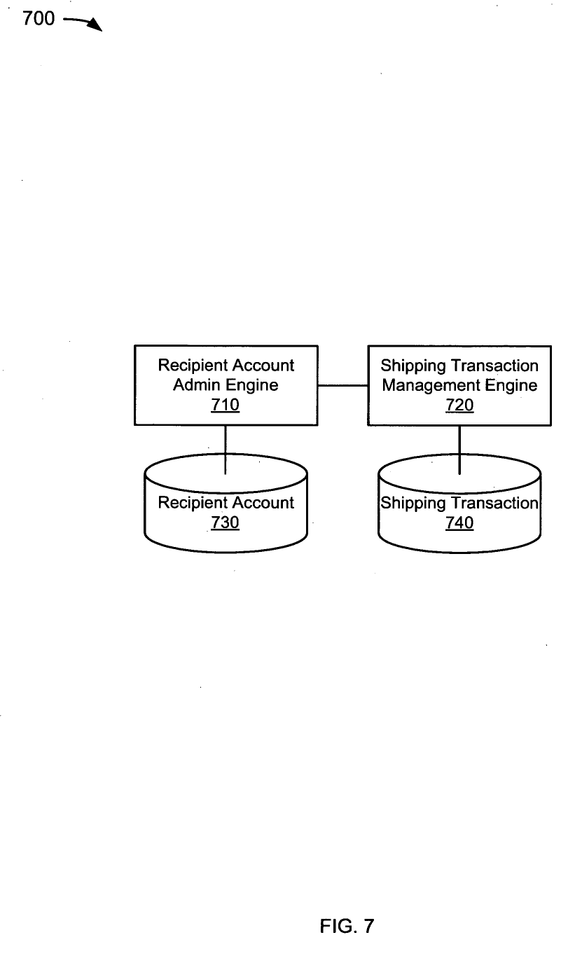

FIG. 7 depicts an example of a recipient account management system 700. The recipient account management engine 140 of FIG. 1 can include or be included in a recipient account management system 700. In the example of FIG. 7, the recipient account management system 700 includes a recipient account admin engine 710 and a shipper transaction management engine 720. The management system 700 further contains a recipient account database 730 to store the information related to recipient accounts, and a shipping transaction database 740 to store in-process delivery operations and historical shipping information. The databases 730 and 740 can be implemented with Relational Database Management System ((RDBMS) such as Oracle®, SQLServer®, or MySQL®, etc. Alternatively, the databases 730 and 740 can be any permanent storage management system such as Excel, Text Files, B-Trees, etc.

In one embodiment, the recipient account admin engine 710 and the shipping transaction management engine 720 provide interfaces to a consumer engine, a provider engine, and a shipper engine (see, e.g., FIG. 1). The interfaces can be web interfaces which are displayable in web browsers. The interfaces can also be implemented via client partitions of the engines 710 or 720. The client partitions can be uploaded to, and be executable directly on, the external systems (e.g., consumer engine, provider engine, and/or shipper engine). Furthermore, the interfaces can be application programming interfaces (APIs) which allow the external systems to invoke the functions provided by the engines 710 or 720 through programming logic.

In one embodiment, the recipient account admin engine 710 can provide services to a consumer, a provider, and/or a shipper in managing and authenticating recipient accounts. The recipient account admin engine 710 can also allow the provider to provide purchasing transaction details and request for payment confirmation. Upon receiving an interface request from a consumer or a provider, the engine 710 can access the recipient account database 730 for relevant information, and respond accordingly. Once a purchasing transaction is committed between the provider and the consumer, relevant transaction details are transmitted from the provider to the shipping transaction management engine 720, and stored in the shipping transaction database 740 for future references.

In one embodiment, the shipping transaction management engine 720 provides services to a consumer, provider, or shipper in coordinating the delivery of the purchased goods. Based on the transaction details retrieved from the shipping transaction database 740, the shipping transaction management engine 720 can inform the shipper about the delivery task, request the shipper to pick up goods from the provider, optionally distribute the payment to the provider, and transmit the consumer's preferred address to the shipper. The shipping transaction management engine 720 can also allow the above parties to check the status of the delivery and information about previous transactions. The details about the interactions among the consumer, the provider, and the shipper were described previously.

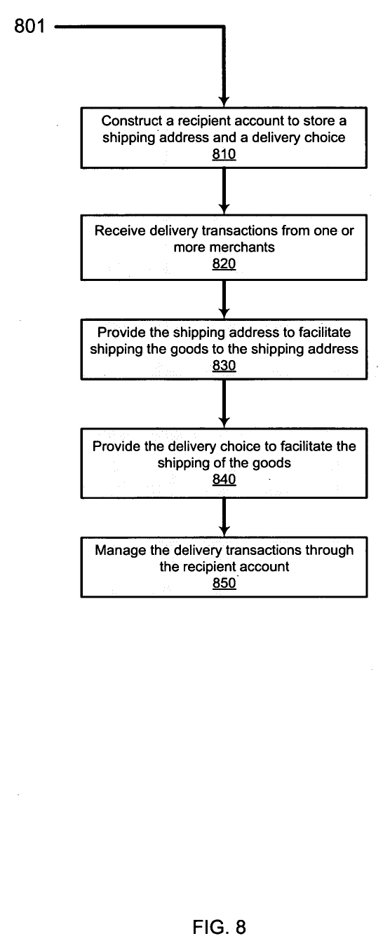

FIG. 8 depicts an example of a process 801 for using a recipient account by a consumer. The process 801 can be performed by computer logic that may comprise hardware (e.g., special-purpose circuitry, dedicated hardware logic, programmable hardware logic, etc.). The process 801 can also be implemented in software (such as instructions that can be executed on a processing device), firmware or a combination thereof embedded in hardware components. In one embodiment, machine-executable instructions for the process 801 can be stored in memory and executed by a processor.

At 810, a consumer constructs a recipient account by utilizing a recipient account management engine provided by a shipper or an independent party. The recipient account stores one or more addresses that can be used for delivery goods to the consumer. The recipient account also contains one or more delivery choices. The delivery choices include the consumer's preferences in shipping vendors and/or deliver services (e.g., overnight, same-day, 3-day, ground, etc). At 820, once the consumer finalizes purchasing transactions with multiple merchants, these merchants can submit multiple delivery transactions to the recipient account management system. These delivery transactions describe what kind of goods to be delivered, and from where these goods can be picked up. Once these delivery transactions are stored in the recipient account management system, the consumer can access his/her recipient account and review these delivery transactions. At 830, the consumer can select one of the shipping addresses he/she prefers for the delivery of the goods specified in these pending delivery transactions. These shipping addresses can be pre-configured in the recipient account, or can be newly added by the consumer. In one embodiment, the address selected by the consumer is provided to the shipping vendors, but is not revealed to the merchants. Alternatively, if the merchants can be trusted, the selected address can be provided to the merchants.

At 840, the consumer can also select one of the delivery choices to specify which shipping vendor and shipping service to use for the delivery of the goods for one, some, or all of the delivery transactions. Alternatively, a default delivery choice can be pre-configured in the recipient account. The selected delivery choice, along with the selected shipping address, can then be provided to the selected shipping vendor. At 850, the shipping vendor can be informed of these delivery transactions, and it can schedule for the picking-up and delivery of the goods, according to the shipping address and the shipping choice made by the consumer. Through his/her recipient account, the consumer can manage these delivery transactions without having to directly interact with the shipping vendor or the merchants.

In one embodiment, the consumer can schedule the delivery of these goods by specify a date of delivery for some or all of the delivery transactions. Thus, the consumer, rather than the merchant or the shipper, becomes the party to determine the delivery schedule. For example, before the goods are picked up by the shipper, the consumer can submit a delivery date to the shipper. Based on the delivery date and the delivery choice, the shipper can schedule an ideal time frame to pick up the goods from the merchant, and deliver the packages to the consumer at the time frame specified by the consumer. The consumer can also change a delivery time frame for some or all of the delivery transactions, without having to contact the shipper or the merchants. Similarly, the consumer can specify a new delivery address or change to a different delivery address based on his/her preference, without having to contact each of the merchants for such update. Upon receiving the updated time frame or the update address, the shipper can reschedule its route accordingly.

Software or firmware to implement the techniques introduced here may be stored on a machine-readable medium and may be executed by one or more general-purpose or special-purpose programmable microprocessors. A “machine-readable medium”, as the term is used herein, includes any mechanism that provides (i.e., stores and/or transmits) information in a form accessible by a machine (e.g., a computer, network device, personal digital assistant (PDA), manufacturing tool, any device with a set of one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Although techniques been described with reference to specific examples and embodiments, it will be recognized that the invention is not limited to the examples and embodiments described, but can be practiced with modification and alteration within the spirit and scope of the appended claims. Accordingly, the specification and drawings are to be regarded in an illustrative sense rather than a restrictive sense.

What is claimed is:

1. A method comprising:
creating, at a provider engine, a sender account for a shipper, the sender account allowing a consumer to purchase goods;
receiving, at the provider engine, a request for a purchase transaction from the consumer, the request not including a shipping address for the consumer;
requesting, at the provider engine, authorization for the purchase transaction from the shipper;
receiving, at the provider engine, authorization for the purchase transaction from the shipper;
providing goods to be shipped to the shipper, wherein the shipping address for the consumer is not known.

2. The method as recited in claim 1, further comprising:
submitting, at the provider engine, a first authentication passcode along with a recipient account identifier associated with a recipient account to the shipper, wherein the shipper transmits the first authentication passcode to a holder of the recipient account;
receiving, at the provider engine, a second passcode from the consumer;
upon a determination that the second passcode is equal to the first authentication passcode, committing the purchase transaction with the consumer.

3. The method as recited in claim 1, further comprising: receiving, at the provider engine, a payment from the shipper, without knowing payment information of the consumer.

4. The method as recited in claim 1, further comprising: tracking the purchase transaction and the shipping of the goods via the shipper without knowing the shipping address of the consumer.

5. The method as recited in claim 1, further comprising:
requesting a payment confirmation from the shipper without knowing how the consumer pays for the payment;
upon receiving the payment confirmation, committing the transaction for purchasing of the goods.

6. The method as recited in claim 1, wherein the user's personal information, payment information and shipping information are maintained by the shipper and are not revealed.

7. The method as recited in claim 1, wherein the method is embodied in a machine-readable medium as a set of instructions which, when executed by a processor, cause the processor to perform the method.

8. A method comprising:
maintaining at a recipient account management engine a recipient account for a user, wherein the recipient account contains the user's payment information and a shipping address;
receiving at the recipient account management engine a request from a provider for authorization of a purchase transaction associated with the recipient account;
determining that the payment information is sufficient to authorize payment;
sending authorization from the recipient account management engine to the provider;
having goods associated with the purchase transaction shipped to the shipping address associated with the recipient account.

9. The method as recited in claim 8, further comprising: having the goods consolidated with other goods for delivery.

10. The method as recited in claim 8, further comprising: having the goods delivered as part of a regularly scheduled delivery.

11. The method as recited in claim 8, further comprising: conducting the purchase transaction on behalf of the user using pre-entered payment information.

12. The method as recited in claim 8, wherein the sending of the authorization includes sending pre-entered payment information.

13. The method as recited in claim 8, wherein the sending of the authorization includes sending credit card information, wherein the credit card information is unverified.

14. The method as recited in claim 8, wherein the determining that the payment information is sufficient includes checking whether credit card information is available.

15. The method as recited in claim 8, wherein the shipping address is one of a plurality of pre-entered shipping addresses.

16. A method comprising:
constructing, via a consumer engine, a recipient account with a shipper, wherein the recipient account contains a user's personal information, a plurality of payment options and a plurality of shipping addresses;
submitting, at the consumer engine, a transaction to a provider for purchasing of goods, wherein the transaction includes a recipient account identifier for receiving payment from the shipper;
upon receiving a notice of the transaction from the shipper, automatically selecting, by the consumer engine, a payment method from the plurality of payment options and a shipping address from the plurality of shipping addresses, wherein the payment method is used by the shipper to transfer the payment to the provide for purchasing of the goods, and the shipping address is utilized by the shipper for shipping the goods, the user's personal information, the plurality of payment information and the plurality of shipping addresses are not revealed to the provider.

17. A system, comprising:
a recipient account admin engine to manage a plurality of recipient accounts, wherein each of the plurality of recipient accounts includes personal information, payment information and shipping addresses for a particular user;
a shipping transaction management engine coupled with the recipient account admin engine, the shipping transaction management engine is configured to
receive a recipient account identifier and a transaction from a provider for purchasing of goods,
retrieve a recipient account from the plurality of recipient accounts based on the recipient account identifier,
authenticate the provider and a holder of the recipient account;
upon authentication of the provider and the holder, transmit a payment confirmation based on the recipient account to the provider without revealing to the provider the recipient account's personal information and payment information.

18. The system as recited in claim 17, wherein the shipping transaction management engine is further configured to: provide one of the shipping addresses retrieved from the recipient account to a shipper for shipping the goods to the recipient account holder, without revealing the shipping addresses to the provider.

19. The system as recited in claim 17, wherein the shipping transaction management engine is further configured to:
transmit a first passcode to the holder for authenticating the provider, wherein the first passcode is to be transmitted by the holder to the provider;
receive a second passcode from the provider;
authenticate the provider by comparing the first passcode and the second passcode, wherein a match between the first passcode and the second passcode authenticates the provider.

20. The system as recited in claim 17, wherein the shipping transaction management engine is further configured to:
review shipping status for the goods delivered from the provider to the recipient account holder;
update the recipient account's payment information without revealing the updated payment information to the provider;
reroute the goods to a different shipping address.

21. A method comprising:
constructing, at a recipient account management engine, a recipient account to store a shipping address and a delivery choice;
receiving a plurality of delivery transactions from one or more merchants, wherein each of the plurality of delivery transactions is to deliver goods purchased from one of the merchants;
providing the shipping address to facilitate shipping the goods to the shipping address;
providing the delivery choice to facilitate shipping the goods in accordance with the delivery choice;
managing the plurality of delivery transactions through the recipient account.

22. The method as recited in claim 21, further comprising: coordinating with one of a plurality of shippers to delivery the goods for one or more of the plurality of delivery transactions to the shipping address.

23. The method as recited in claim 21, further comprising: coordinating with one of a plurality of shippers to deliver the goods for one or more of the plurality of delivery transactions at a common time frame.

24. The method as recited in claim 21, further comprising: changing delivery of goods for one or more of the plurality of delivery transactions to a different address.
